(19) United States
(12) Patent Application Publication
(10) Pub. No.: US 2017/0153811 A1
(43) Pub. Date: Jun. 1, 2017

(54) DISPLAY APPARATUS AND DISPLAYING METHOD THEREOF

(71) Applicant: SAMSUNG ELECTRONICS CO., LTD., Suwon-si (KR)

(72) Inventors: Sung-hyuk KWON, Suwon-si (KR); Ji-bum MOON, Seoul (KR); Jong-bo MOON, Suwon-si (KR); Valeriya GUSEVA, Suwon-si (KR); Dong-hun LEE, Suwon-si (KR); Sang-jin HAN, Gunpo-si (KR); Moon-sung NA, Suwon-si (KR)

(73) Assignee: SAMSUNG ELECTRONICS CO., LTD., Suwon-si (KR)

(21) Appl. No.: 14/953,079

(22) Filed: Nov. 27, 2015

(51) Int. Cl. G06F 3/0488; G06F 3/01

(52) U.S. Cl. CPC G06F 3/04886; G06F 3/018

(57) ABSTRACT

A method for inputting letters in a display apparatus are provided. The method includes displaying an input user interface (III) including a plurality of letter items arranged in a row, each of the plurality of letter items representing at least one letter, receiving a user command to select a letter item from the plurality of letter items, and displaying, in response to the user command, an extension UI including at least one letter item related to the selected letter item around the selected letter item, the at least one letter item included in the extension UI representing at least one letter or at least one input function.

### CROSS-REFERENCE TO RELATED APPLICATION

This application claims priority from Korean Patent Application No. 10-2014-0167716, filed on Nov. 27, 2014 in the Korean Intellectual Property Office, the disclosure of which is incorporated herein by reference in its entirety.

### BACKGROUND

### Field

Methods and apparatuses consistent with exemplary embodiments relate to a display apparatus and a displaying method thereof, and more particularly, to a method and a display apparatus for enabling a user to input text easily.

### Description of the Related Art

A recent display apparatus often functions as a hub device of peripherals through connection with various devices. Furthermore, a user is able to watch various web contents through internet access by using the display apparatus. In addition, a display apparatus, such as a smart TV, has been developed to enhance usability through diverse applications.

Accordingly, a growing number of users input text through the display apparatus in order to perform a web search operation or retrieve a content.

However, in case of a display apparatus having a relatively large display, for example, a TV, it may be difficult to input text through a touch input or the existing button-type remote controller.

In addition, it may be difficult for a user to watch a displayed content without interruption while the user manipulates a display apparatus.

Accordingly, there is a need for a method of easily inputting text without interrupting content display.

### SUMMARY

The disclosure has been provided to address the aforementioned and other problems and disadvantages occurring in the related art, and an aspect of the disclosure provides a display apparatus which facilitates the text input without interrupting a content display and a displaying method thereof.

According to an aspect of an exemplary embodiment, there is provided a display apparatus comprising, a display configured to display an input user interface (UI) including a plurality of letter items arranged in a row, each of the plurality of letter items representing at least one letter; an input unit configured to receive user commands; and a controller configured to, in response to a user command to select a letter item from the plurality of letter items being received through the input unit, control the display to display an extension UI including at least one letter item related to the selected letter item around the selected letter item, the at least one letter item included in the extension UI representing at least one letter or at least one input function.

The at least one input function may comprise at least one of inputting one of letters represented by the selected letter item, inputting an empty space, and deleting an input letter.

In response to a letter represented by the selected letter item being a Hangul consonant, the controller may control the at least one letter item included in the extension UI to represent a Hangul vowel.

In response to a letter represented by the selected letter item being an English letter, the controller may control the extension UI to include a recommended English letter which is suitable to come after the English letter.

At least one of the plurality of letter items may represent a plurality of letters.

In response to the user command to select the at least one letter item being received, the controller may control the display to display each of the plurality of letters in a separate letter item.

According to another aspect of an exemplary embodiment, there is provided a display apparatus comprising, a display configured to display a plurality of letter items in a row, each letter item representing at least one letter; an input unit configured to receive user commands; and a controller configured to, in response to receiving a first user command to select a letter item representing a plurality of letters, control the display to display a highlight on the selected letter item, and in response to receiving a second user command to select a letter from the plurality of letters, input the selected letter in an input window.

The controller may control the display to display a letter item representing at least one input function in the row.

According to another aspect of an exemplary embodiment, there is provided a displaying method of a display apparatus, the method comprising: displaying an input user interface (UI) including a plurality of letter items arranged in a row, each of the plurality of letter items representing at least one letter; receiving a user command to select a letter item from the plurality of letter items; and displaying, in response to the user command, an extension UI including at least one letter item related to the selected letter item around the selected letter item, the at least one letter item included in the extension UI representing at least one letter or at least one input function.

The at least one input function may comprise at least one of inputting one of letters represented by the selected letter item, inputting an empty space, and deleting an input letter.

The displaying the extension UI may comprise displaying a Hangul vowel in the extension UI in response to a letter represented by the selected letter item being a Hangul consonant.

In response to a letter represented by the selected letter item being an English letter, the extension UI may include a recommended English letter which is suitable to come after the English letter.

At least one of the plurality of letter items may represent a plurality of letters.

The method may further comprise displaying, in response to the user command to select the at least one letter item being received, each of the plurality of letters in a separate letter item.

According to another aspect of an exemplary embodiment, there is provided a displaying method of a display apparatus, the method comprising, displaying a plurality of letter items in a row, each letter item representing at least one letter; displaying, in response to receiving a first user command to select a letter item representing a plurality of letters, a highlight on the selected letter item; and inputting, in response to receiving a second user command to select a letter from the plurality of letters represented by the selected letter item, the selected letter in an input window.

The method may further comprise displaying at least one letter item representing at least one input function in the row.

According to above-described various exemplary embodiments, a user is able to use a display apparatus which facilitates a text input on a small screen without interruption while watching a content displayed on the screen.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a block diagram illustrating a structure of a display apparatus according to an exemplary embodiment;

FIG. 2 illustrates an extension UI for inputting Hangul according to an exemplary embodiment;

FIG. 3A illustrates an input UI for inputting English according to an exemplary embodiment;

FIGS. 3B and 3C illustrate an extension UI for inputting English according to an exemplary embodiment;

FIGS. 4A to 4C illustrate an extension UI to display letters included in a letter item of an input UI separately according to an exemplary embodiment;

FIGS. 5A and 5B illustrate an input UI including a recommend word window according to an exemplary embodiment;

FIGS. 6A to 6C illustrate an input UI in which an word is searched using a recommended word window according to an exemplary embodiment;

FIGS. 7A to 7C illustrate an input UI in which a letter item includes a plurality of letters for inputting a Hangul letter according to an exemplary embodiment;

FIG. 8 is a flowchart illustrating a method of displaying an input UI and an extension UI according to an exemplary embodiment; and

FIG. 9 is a flowchart illustrating a method of inputting a letter according to an exemplary embodiment.

### DETAILED DESCRIPTION OF THE PREFERRED EMBODIMENT

Exemplary embodiments are described in greater detail below with reference to the accompanying drawings.

In the following description, same drawing reference numerals are used for the same elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

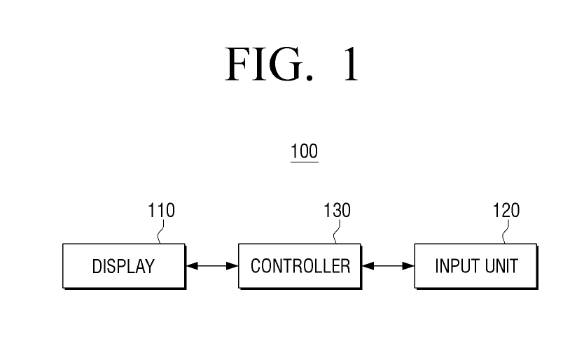

FIG. 1 is a block diagram illustrating a structure of a display apparatus according to an exemplary embodiment. As illustrated in FIG. 1, a display apparatus 100 may include a display 110, an input unit 120, and a controller 130. The display apparatus 100 may be, but is not limited to, a TV. For example, the display apparatus 100 may be realized as various electronic apparatuses such as a mobile phone, a tablet Personal Computer (PC), a digital camera, a camcorder, a laptop PC, a Personal Digital Assistant (PDA), and the like having the display 110.

The display 110 displays an image. The display 110 may display a content received through a broadcast channel. That is, the display apparatus 100 may receive various broadcast signals transmitted from a broadcasting station through a Radio Frequency (RF) communication network or may receive contents from various servers through an IP network. In addition, the display 110 may display the received contents.

The display 110 may display diverse UIs. For example, the display 110 may display an input UI for inputting a letter. display 110 The input UI including a plurality of letter items arranged in a row.

Each of the plurality of letter items may represent, i.e., display, one or more letters. Also, a letter item may represent one or more functions. A user may input a letter or execute a specific input function, e.g., space and backspace, using a proper letter item corresponding to, i.e., representing, the letter or the function.

For example, in case of inputting English, one letter item may include one or more letters of alphabet.

If the letter items in the Input UI are arranged in a row and some letter items include two or more English letters being displayed, a distance between the displayed letter items may increase.

The input unit 120 receives a user command In case of the display apparatus 100 including a touch pad, the input unit 120 may receive a user command by a touch. The input unit 120 may also receive a user command inputted using other interface without a user's touch. That is, the input unit 120 may be realized using four-directional buttons, a touch pad, and a motion sensor, etc.

Meanwhile, the input unit 120 may include a camera. Accordingly, the input unit 120 may receive a user command through a user motion photographed by the camera.

The controller 130 controls overall operations of the display apparatus 100. If a user command to select one of the plurality of letter items are received through the input unit 120, the controller 130 may control the display 110 to display an extension UI including at least one letter item related to the selected letter item around the selected letter item.

That is, in response to a user command being received, the controller 130 may control the display 110 to display an extension UI for inputting an upper part or a lower part of the selected letter item, inputting an empty space in an overlapping manner, or deleting an inputted letter.

If a letter displayed in the selected letter item is a Hangul consonant, the controller 130 may control the extension UI for displaying a Hangul vowel. If the letter displayed in the selected letter item is an English letter, the controller 130 may control the extension UI to include a recommended English letter which is likely to follow the selected letter.

In case of other languages than Hangul or English, a language displayed in the input UI and the extension UI may be changed in accordance with orthography and grammar of the language.

If a letter item includes a plurality of letters and a user selects the letter item, the controller 130 may control the display 110 to divide the plurality of letters onto a letter item and an extension UI.

For example, if a letter item includes two letters being displayed and a user selects the letter, the controller 130 may control the display 110 to divide the two letters included in the letter item and then display one letter in the letter item and the other letter in the extension UI.

When one of the letter items is selected, the controller 130 may control the display 110 to display a highlight on the selected letter item. When a letter in the selected letter item is selected, the controller 130 may input the selected letter in an input window.

For example, the controller 130 may control one of the plurality of letter items to be selected according to a user command input through the input unit 120 to move a cursor in a horizontal or vertical direction by a touch, a button, a motion, etc.

Meanwhile, the letter item may include a function UI which shows various functions for inputting texts, e.g., English letters, Hangul consonants, and Hangul vowels. In addition, one letter item may include a plurality of function UIs.

For example, one letter item may include function UIs which represent functions corresponding to ‘space,’ ‘back space,’ and ‘enter.’ Alternatively, one letter item may include function UIs which represent functions corresponding to ‘favorite’ and ‘recently searched.’

The display 110, the controller 130, and the input unit 120 may be implemented as a software, a hardware, or a combination of both.

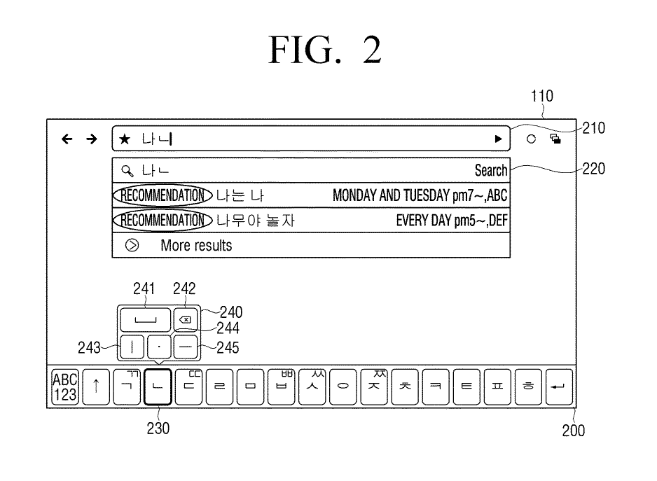

FIG. 2 illustrates an extension UI for inputting Hangul according to an exemplary embodiment.

As illustrated in FIG. 2, the controller 130 may control the display 110 to display an input UI 200 including letter items, each of which represents one Hangul consonant. With a UI for inputting text including many columns, a substantial portion of the display 110 is blocked by the UI. Accordingly, it may cause inconvenience to the user to display the UI while a user watches a content.

In order to prevent such an interruption display 110, display 110 the letter items may be arranged in a row.

In addition, the controller 130 may control the display 110 to display an input window 210 for displaying input text and a result window 220 for performing a search operation according to the input letter and/or for displaying a recommended search result.

The display apparatus 100 may receive a user command to select one of the plurality of letter items through the input unit 120. Specifically, if the input unit 120 includes four-directional buttons, the user may select one of the plurality of letter items by pressing one of the buttons move a cursor.

If the input unit 120 includes a touch pad, the user may select one of the plurality of letter items with a dragging input on the touch pad to move a cursor.

If the input unit 120 includes a camera, the user may select one of the plurality of letter items by a user motion using a part of the user's body, e.g., a finger or a hand, which may be photographed and detected by the camera.

The controller 130 may control the display 110 to highlight one of the plurality of letter items according to the user command to move a cursor through the plurality of letter items. For example, the display 110 may render an edge of the selected letter item in bold or change a color of the selected letter item.

If a user presses a confirm menu included in the input unit 120, the letter of the currently highlighted letter item, i.e., selected letter item, may be input in the input window 210. Alternatively, the letter displayed in the currently highlighted letter item may be input in the input window 210 after a predetermined time elapses without any further input.

As illustrated in FIG. 2, if a user selects a Hangul consonant ‘ [symbol] ’ through the input unit 120, the controller 130 may control the display 110 to highlight a letter item 230 corresponding to the selected consonant ‘ [symbol] .’ That is, the display 110 may render an edge of the selected letter item 230 in bold or change a color of the selected letter item 230.

In addition, in response to the letter item being selected, the controller 130 may control the display 110 to display an extension UI 240 including at least one letter item related to the selected letter around the selected letter item.

That is, as illustrated in FIG. 2, the extension UI 240 may include the items which represent ‘space’ 241 and ‘back space’ 242, respectively.

In case of Hangul, in response to the consonant ‘ [symbol] ’ being selected as described above, the controller 130 may control the display 110 to display the extension UI 240 including letter items 243, 244, 245 for inputting vowels.

If the input unit 120 includes four-directional buttons and a user presses an up button, the controller 130 may highlight the extension UI 240, such that the user may be able to select one of the letter items included in the extension UI 240 by inputting a user command to move a cursor with the four-directional buttons included in the input unit 120.

If the input unit 120 includes a touch pad, the controller 130 may highlight the extension UI 240 in response to a user's upward dragging input on the touch pad and then the user is able to select one of the letter items included in the extension UI 240 by inputting a user command to move in the upward, downward, left, or right direction on the touch pad.

If the input unit 120 includes a camera which photographs a user motion of moving a part of the user's body, for example, a finger or a hand, the controller 130 may highlight the extension UI 240. Accordingly, the user is able to select one of the letter items included in the extension UI 240 by inputting a user command to move a cursor by the motion.

Although the above described exemplary embodiment describes the input unit 120 including one or more of the four-directional buttons, the touch pad, and the camera, the input unit 120 may be implemented in various forms for receiving a user command For example, the input unit 120 may include a motion sensor for sensing a user motion.

The input unit 120 may include more than one interface for receiving a user command. Accordingly, for example, the user may input a command to move a cursor through a motion input, and input another command to select an item included in the extension UI 240 by using the four-directional buttons.

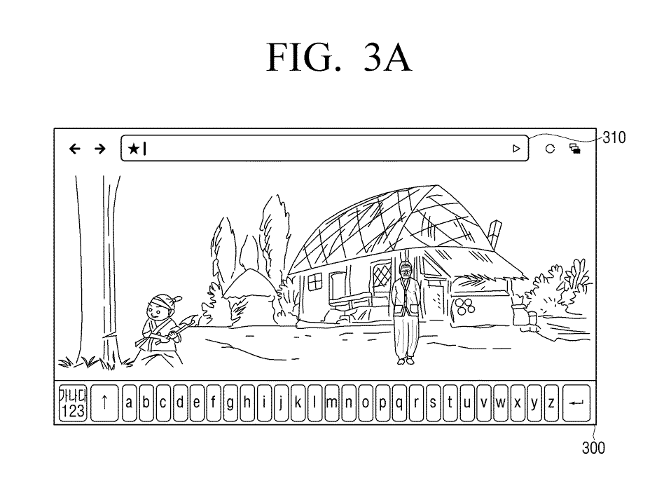

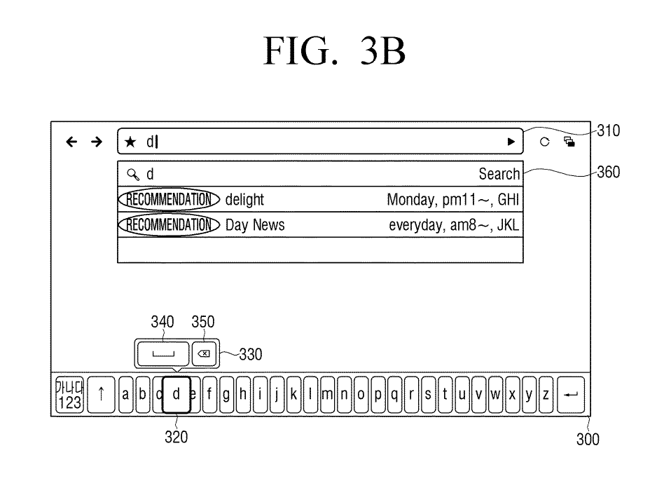

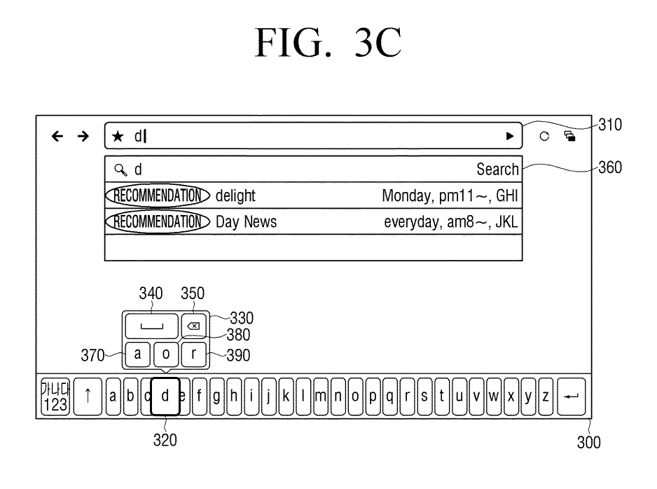

Hereinafter, an exemplary embodiment for inputting an English letter through an input UI and an extension UI will be described with reference to FIGS. 3A through 3C.

As illustrated in FIG. 3A, an input UI 300 including letter items, each of which include one English letter, is displayed. With a UI for inputting text including many columns, a substantial portion of the display 110 is blocked by the UI. Accordingly, it may cause inconvenience to the user to display the UI while a user watches a content.

In order to prevent such an interruption, the controller 130 may control the display 110 to display the input UI 200 including many letter items arranged in a row.

In addition, the controller 130 may control the display 110 to display an input window 310 for displaying input text and a result window for performing a search operation according to the input letter and/or for displaying a recommended search result.

The display apparatus 100 may receive a user command to select one of the plurality of letter items through the input unit 120. For example, the user may select one of the plurality of letter items by pressing one of four-directional buttons to move a cursor.

If the input unit 120 includes a touch pad, the user may select one of the plurality of letter items by inputting a drag command on the touch pad.

If the input unit 120 includes a camera, the user may select one of the letter items by a user motion of moving a part of the user's body, for example, a finger or a hand, to the left or to the right, which is photographed and detected by the camera.

The controller 130 may control the display 110 to highlight one of the plurality of letter items according to the user command while a command to move a cursor in the plurality of letter items is received by an input of pressing a button, a touch input, a motion input, etc. That is, the display 110 may render an edge of the selected letter item in bold or change a color of the selected letter item according to the user command

When a user presses a confirm menu included in the input unit 120 or touch a touch pad for a long time, the controller 130 may input a letter in the currently highlighted letter item in the input window 310. Alternatively, the controller 130 may input in the currently highlighted letter item in the input window 310 after a predetermined time elapses without any further input.

For example, as illustrated in FIG. 3B, in response to a user command to select an English letter ‘d’, the controller 130 may highlight a letter item 320 corresponding to the selected English letter ‘d.’ That is, display 110 an edge of the selected letter item 320 may be rendered in bold or a color of the selected letter item 320 may be changed, when the letter item 320 is selected. Further, as illustrated in FIG. 3B, a size and/or a shape of the selected letter item 320 may be changed, e.g., enlarged, when the letter item 320 is selected.

In response to a letter item being selected, an extension UI 330 including at least one letter item related to the selected letter may be displayed around the selected letter item.

In FIG. 3B, the extension UI 330 may include two items which represent ‘space’ 340 and ‘back space’ 350, respectively.

In another exemplary embodiment of FIG. 3C, the extension UI 330 includes the letter items which represent functions ‘space’ 340 and ‘back space’ 350 as well as other letter items 370, 380, 390 corresponding to recommended English letters which frequently come next to the selected English letter ‘d’ 320 in words.

If the input unit 120 includes four-directional buttons and a user presses an up button, the controller 130 may highlight the extension UI 330. Accordingly, the user is able to select one of the letter items included in the extension UI 330 by inputting a user command using the four-directional buttons included in the input unit 120.

If the input unit 120 includes a touch pad, in response to a user drag command to move up a cursor, the controller 130 may highlight the extension UI 330. Accordingly, the user is able to select one of the letter items included in the extension UI 330 by inputting a user command on the touch pad.

If the input unit 120 includes a camera which photographs a user motion of moving a part of the user's body, for example, a finger or a hand, the controller 130 may highlight the extension UI 240. Accordingly, the user is able to select one of the letter items included in the extension UI 240 by inputting a user command to move a cursor by the motion.

Although the above described exemplary embodiment describes the input unit 120 including one or more of the four-directional buttons, the touch pad, and the camera, the input unit 120 may be implemented in various forms for receiving a user command For example, the input unit 120 may include a motion sensor for sensing a user motion.

The input unit 120 may include more than one interface for receiving a user command Accordingly, for example, the user may input a command to move a cursor in the plurality of input UIs 300 through a motion input, and input another command to select an item included in the extension UI 330 by using the four-directional buttons.

Meanwhile, as illustrated in FIGS. 3B and 3C, in response to a letter being input, a result window 360 may be displayed, which displays a search result. The search result may start with the input letter and/or may be related to the input letter.

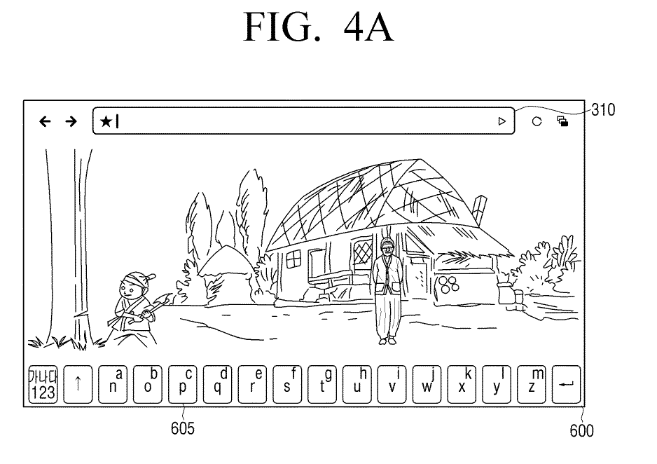

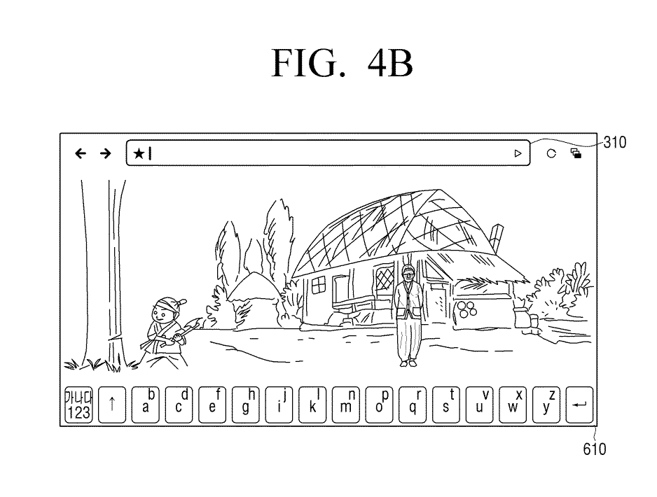

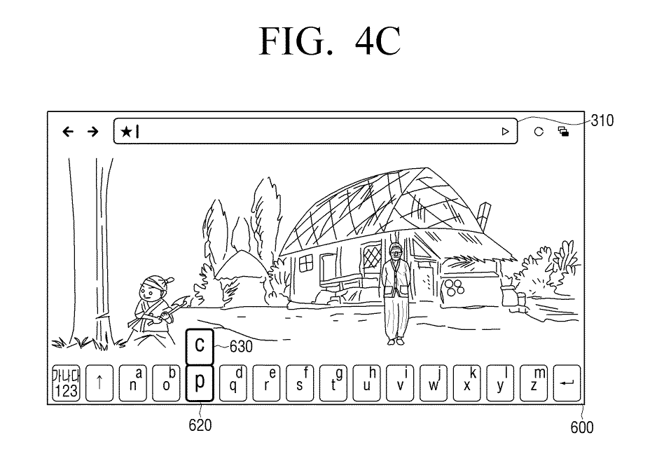

Hereinafter, an exemplary embodiment in which one letter item includes a plurality of letters will be described with reference to FIGS. 4A through 4C.

As illustrated in FIG. 4A and FIG. 4B, the controller 130 may control each of a plurality of items to include two English letters. FIG. 4A and FIG. 4B are different only in terms of an arrangement order of the English letters. That is, the English letters may be arranged in various forms according to a setting of the display apparatus 100 or a user setting, including the arrangements in FIGS. 4A and 4B.

FIG. 4C illustrates an exemplary embodiment in which an item including two English letters is selected.

As described above, if a user moves a cursor left or right using four-directional buttons, a touch pad, a motion sensor, or a camera included in the input unit 120, the controller 130 may highlight the selected letter item according to the user command

In addition, in response to one of the plurality of letter items being selected according to a user command to press a confirm button included in the input unit 120, a user command to touch a touch pad for a long time, or a user command to take a motion corresponding to a ‘confirm’ function, the extension UI may be displayed.

For example, if a user selects a letter item 605 including the English letters ‘c’ and ‘p’ in FIG. 4A, the controller 130 may divide the English letters ‘c’ and ‘p’ onto separate letter items. To be specific, as illustrated in FIG. 4C, ‘p’ is displayed in the selected letter item 620 and ‘c’ is displayed in the extension UI 630 located on top of the selected letter item 620.

If a user selects the selected letter item 620, ‘p’ may be input in the input window 310. Also, if a user selects the extension UI 630, ‘c’ may be input in the input window 310.

In another exemplary embodiment, a letter item may include three or more letters.

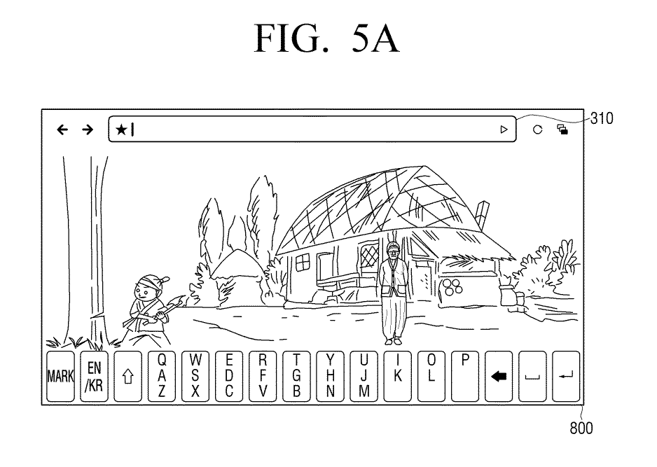

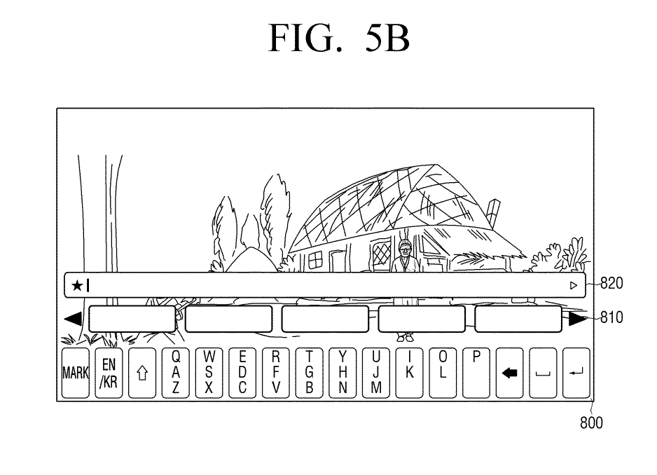

In FIG. 5A, an input UI 800 provides letter items including one to three English letters. The English letters may be arranged in a different order depending upon the setting of the display apparatus 100 or the user setting.

As illustrated in FIG. 5B, an input window 820 and a recommended word window 810 are displayed in the input UI 800. If one of the plurality of letter items is selected and subsequently one of letters included in the selected letter item is selected, the controller 130 may input the letter in the input window 820. In addition, a recommended word which starts with the inputted letter or is related to the inputted letter may be displayed in the recommended word window 810.

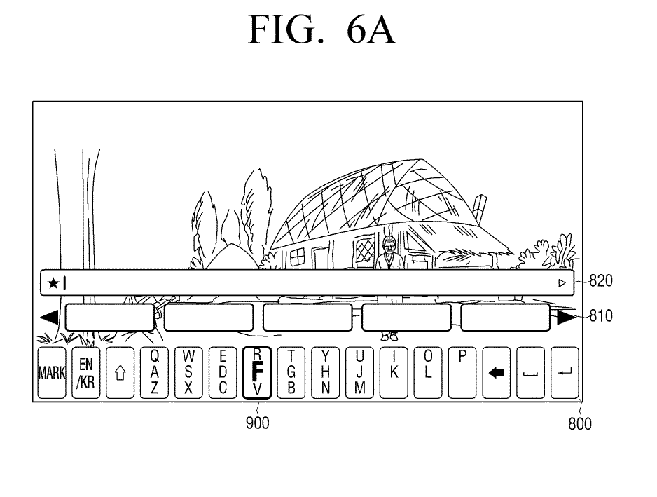

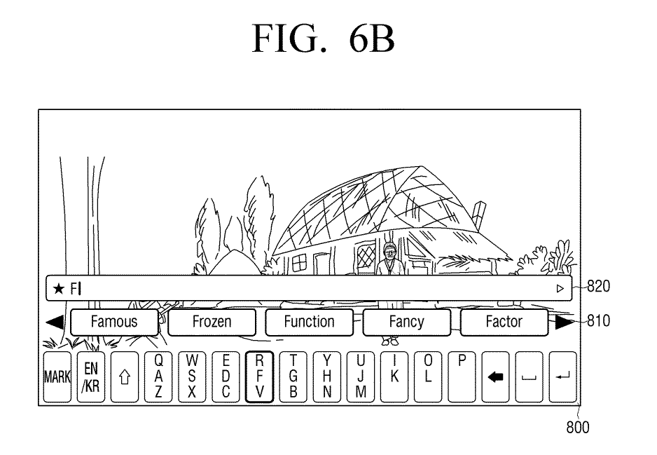

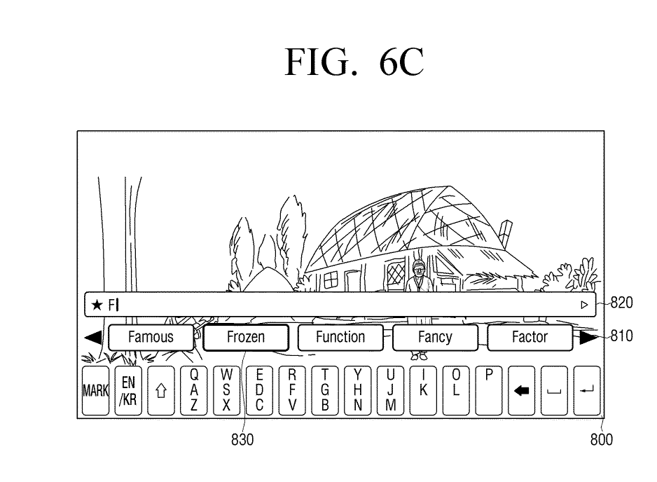

Hereinafter, an exemplary embodiment for inputting a letter through the input UI 800 illustrated in FIGS. 5A and 5B will be described in detail with reference to FIGS. 6A to 6C.

The display apparatus 100 may receive a user command to select one of the plurality of letter items through the input unit 120. For example, if the input unit 120 includes four-directional buttons, the user may select one of the plurality of letter items by inputting a user command to press a button to move to the left or to the right.

If the input unit 120 includes a touch pad, the user may select one of the plurality of letter items with a dragging input on the touch pad to move a cursor.

If the input unit 120 includes a camera, the user may select one of the plurality of letter items by a user motion using a part of the user's body, e.g., a finger or a hand, which may be photographed and detected by the camera.

The display 110 may display a highlight on one of the plurality of letter items according to the user command to move a cursor. For example, the display 110 may render an edge of the selected letter item in bold or change a color of the selected letter item.

For example, as illustrated in FIG. 6A, in response to a letter item 900 including ‘R,’ ‘F,’ and ‘V’ being selected, the controller 130 may render an edge of the letter item 900 in bold.

If a user selects one of the plurality of letter items and subsequently selects one of the plurality of letters included in the selected letter item 900, the controller 130 may highlight the selected letter and display the letter in the input window 820.

A user command to select one of the plurality of letters included in the selected letter item 900 may be input in various forms.

For example, if the input unit 120 includes a four-directional button, the highlight may be shifted to the next letter in the selected letter item 900 as a user presses the up button or the down button.

If the input unit 120 includes a touch pad, the highlight may be shifted to the next letter in the selected letter item 900 as a user drags up or down a touch point on the touch pad.

If the input unit 120 includes a motion sensor, the highlight may be shifted to the next letter in the selected letter item 900 as a user moves up or down the motion sensor.

If the input unit 120 includes a camera which photographs a user motion to receive a user command, the highlight may be shifted to the next letter in the selected letter item 900 in response to the user motion to move up or down a cursor.

In other exemplary embodiments, the highlight may be shifted to the next letter in the selected letter item 900 as the user input command to move a cursor in other directions, e.g., left or right.

As illustrated in FIG. 6B, if a user confirms the selection by, for example, pressing a confirm button or touching a touch pad for a long time, the letter displayed in the currently highlighted letter is input in the input window 820. Also, when a predetermined time elapses without any input after one letter is highlighted, the highlighted letter may be input in the input window 820.

For example, as illustrated in FIG. 6B, ‘F’ is selected and the display 110 displays the English letter ‘F’ in the input window 310. At this point, recommended words which start with the selected English letter ‘F’, e.g., ‘famous,’ ‘frozen,’ ‘function,’ ‘fancy,’ etc., may be displayed in the recommended word window 810 according to a frequency of use.

In response to the user command to move a cursor to the recommended word window 810 being received, the controller 130 may control one of the items included in the recommended word window 810 to be highlighted. In response to a user command to search a word included in the highlighted item being received, a search operation with respect to the word may be performed immediately even though the word are not input entirely by the user.

For example, as illustrated in FIG. 6C, an item 830 including a word ‘frozen’ is selected after the user input only ‘f’ in the input window 820. If the user confirms the selection of the item 830, a search may be performed with respect to ‘frozen’ on the internet.

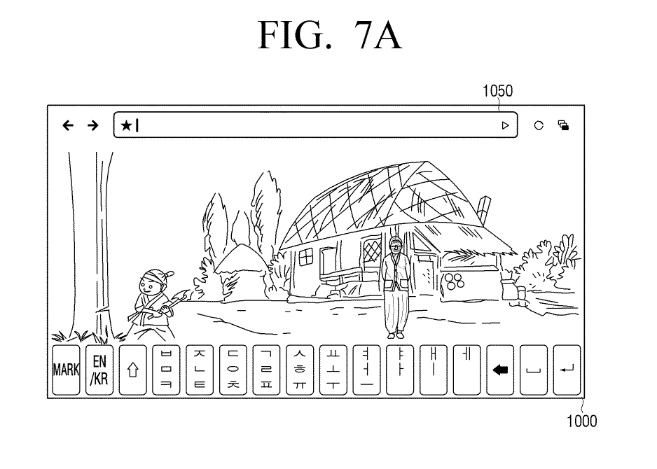

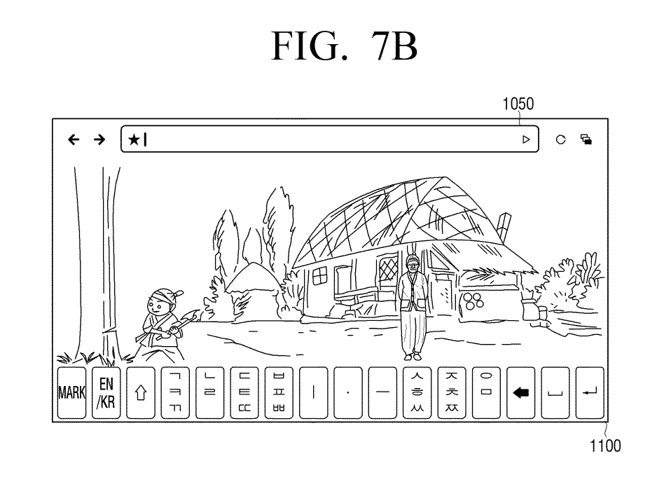

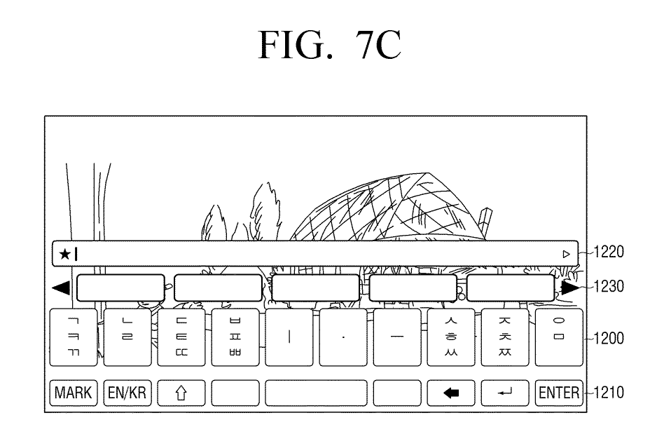

Hereinafter, an exemplary embodiment in which Hangul is input through a letter item will be described with reference to FIGS. 7A to 7C.

As illustrated in FIG. 7A, a letter item may include at least one consonant or one vowel.

In another exemplary embodiment, as illustrated in FIG. 7B, only three letter items may be used for inputting the vowels and all consonants may be included in other letter items.

In addition, as illustrated in FIG. 7C, an input window 1220 for displaying a selected letter, a recommended word window 1230, and a plurality of function items 1220 may be displayed along with the input UI 1200.

In case of inputting the Hangul, text may be easily input according to a user command to move a cursor through the plurality of letter items as described above.

A letter item may be displayed as a function UI for functions relevant to inputting letters. For example, one letter item may include a function UI for functions, such as ‘favorite,’ ‘recently search list,’ and ‘recommended content.’

As described above, as one letter item includes a letter UI or a function UI for inputting a plurality of letters, the user is able to input the text efficiently on a small screen without being interrupted when the user watches a content displayed in the display 110.

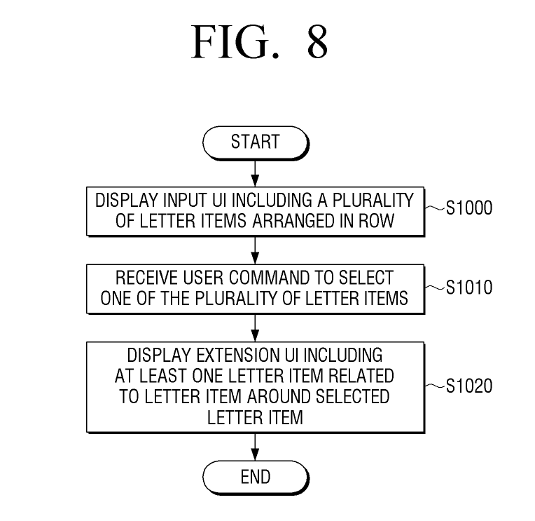

FIG. 8 is a flowchart illustrating a method of displaying an input UI and an extension UI according to an exemplary embodiment.

The display apparatus 100 displays an input UI including a plurality of letter items arranged in a row (S1000).

The letter item may include one Hangul consonant, one Hangul vowel, or one English letter. With a UI for inputting text including many columns a substantial portion of the display 110 is blocked by the UI. Accordingly, it may cause inconvenience to the user to display the UI while a user watches a content.

In order to prevent such an interruption display 110, display 110 the letter items may be arranged in a row.

An input window for displaying input text and a result window for performing a search operation according to the input letter or displaying a recommended search result may be displayed along with the input UI.

In response to receiving a user command to select one of the plurality of letter items, the display apparatus 100 may display an extension UI including at least one letter item related to the selected letter item around the selected letter item (S1020).

Specifically, if the input unit 120 includes four-directional buttons, the user may select one of the plurality of letter items by pressing one of the buttons move a cursor.

If the input unit 120 includes a touch pad, the user may select one of the plurality of letter items with a dragging input on the touch pad to move a cursor.

If the input unit 120 includes a camera, the user may select one of the plurality of letter items by a user motion using a part of the user's body, e.g., a finger or a hand, which may be photographed and detected by the camera.

The display apparatus 100 may display a highlight on one of the plurality of letter items according to the user command to move a cursor through the plurality of letter items. For example, the display apparatus 100 may render an edge of the selected letter item in bold or change a color of the selected letter item.

If a user presses a confirm menu included in the input unit 120, the letter of the currently highlighted letter item, i.e., selected letter item, may be input in the input window 210. Alternatively, the letter displayed in the currently highlighted letter item may be input in the input window after a predetermined time elapses without any further input.

Meanwhile, the extension UI may include the items which represent ‘space’ for inputting a null letter and ‘back space’ for deleting an input letter. In case of Hangul, in response to one of a plurality of consonants being selected by the user, the extension UI may include an item for inputting a vowel.

In case of English, in response to one of a plurality of English letters being selected by the user, the extension UI may include English letters which is frequently used with the selected English letter in succession or determined to be suitable to be used with the selected English letter in succession, as well as the items which represent ‘space’ and ‘back space.’

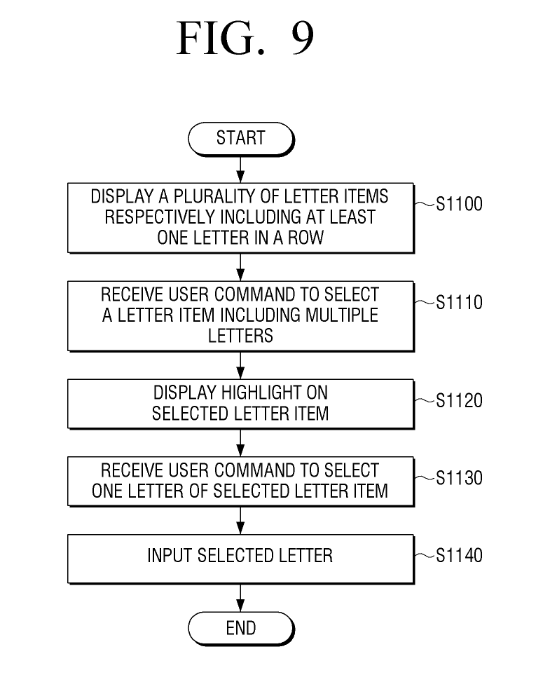

FIG. 9 is a flowchart illustrating a method of inputting a letter using a plurality of letter items, each of which includes one or more letters.

The display apparatus 100 displays a plurality of letter items which respectively include at least one letter in a row (S1100). For example, each of the plurality of letter items may include one or more English letters.

If one of the plurality of letter items which includes multiple letter is selected (S1110), the display apparatus 100 displays a highlight on the selected letter item (S1120).

If a user selects one of the multiple letters included in the selected letter item (S1130), the selected letter is input in an input window (S1140).

The methods according to various exemplary embodiments may be implemented as a software and stored in a non-transitory readable medium. The non-transitory readable medium may be mounted and used in diverse apparatuses.

The non-transitory readable medium refers to a medium which may store data permanently or semi-permanently rather than storing data for a short time such as a register, a cache, and a memory and may be readable by an apparatus. As an example, the above-described various applications and programs may be stored in the non-transitory readable medium such as a compact disc (CD), a digital versatile disk (DVD), a hard disk, a Blu-ray disk, a universal serial bus (USB), a memory card, a read-only memory (ROM), and the like.

The foregoing exemplary embodiments and advantages are merely exemplary and are not to be construed as limiting the disclosed inventive concept. The exemplary embodiments may be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display configured to display an input user interface (UI) including a plurality of letter items arranged in a row, each of the plurality of letter items representing at least one letter;
an input unit configured to receive user commands; and
a controller configured to, in response to a user command to select a letter item from the plurality of letter items being received through the input unit, control the display to display an extension UI including at least one letter item related to the selected letter item around the selected letter item, the at least one letter item included in the extension UI representing at least one letter or at least one input function.

2. The apparatus as claimed in claim 1, wherein the at least one input function comprises at least one of inputting one of letters represented by the selected letter item, inputting an empty space, and deleting an input letter.

3. The apparatus as claimed in claim 1, wherein in response to a letter represented by the selected letter item being a Hangul consonant, the controller controls the at least one letter item included in the extension UI to represent a Hangul vowel.

4. The apparatus as claimed in claim 1, wherein in response to a letter represented by the selected letter item being an English letter, the controller controls the extension U1 to include a recommended English letter which is suitable to come after the English letter.

5. The apparatus as claimed in claim 1, wherein at least one of the plurality of letter items represents a plurality of letters.

6. The apparatus as claimed in claim 5, wherein in response to the user command to select the at least one letter item being received, the controller controls the display to display each of the plurality of letters in a separate letter item.

7. A display apparatus comprising:
a display configured to display a plurality of letter items in a row, each letter item representing at least one letter;
an input unit configured to receive user commands; and
a controller configured to, in response to receiving a first user command to select a letter item representing a plurality of letters, control the display to display a highlight on the selected letter item, and in response to receiving a second user command to select a letter from the plurality of letters, input the selected letter in an input window.

8. The apparatus as claimed in claim 7, wherein the controller controls the display to display a letter item representing at least one input function in the row.

9. A displaying method of a display apparatus, the method comprising:
displaying an input user interface (UI) including a plurality of letter items arranged in a row, each of the plurality of letter items representing at least one letter;
receiving a user command to select a letter item from the plurality of letter items; and
displaying, in response to the user command, an extension UI including at least one letter item related to the selected letter item around the selected letter item, the at least one letter item included in the extension UI representing at least one letter or at least one input function.

10. The method as claimed in claim 9, wherein the at least one input function comprises at least one of inputting one of letters represented by the selected letter item, inputting an empty space, and deleting an input letter.

11. The method as claimed in claim 9, wherein the displaying the extension UI comprises displaying a Hangul vowel in the extension UI in response to a letter represented by the selected letter item being a Hangul consonant.

12. The method as claimed in claim 9, wherein in response to a letter represented by the selected letter item being an English letter, the extension UI includes a recommended English letter which is suitable to come after the English letter.

13. The method as claimed in claim 9, wherein at least one of the plurality of letter items represents a plurality of letters.

14. The method as claimed in claim 13, further comprising:
displaying, in response to the user command to select the at least one letter item being received, each of the plurality of letters in a separate letter item.

15. A displaying method of a display apparatus, the method comprising:
displaying a plurality of letter items in a row, each letter item representing at least one letter;
displaying, in response to receiving a first user command to select a letter item representing a plurality of letters, a highlight on the selected letter item; and
inputting, in response to receiving a second user command to select a letter from the plurality of letters represented by the selected letter item, the selected letter in an input window.

16. The method as claimed in claim 15, further comprising,
displaying at least one letter item representing at least one input function in the row.
